(19) United States
(12) Patent Application Publication
(10) Pub. No.: US 2004/0246524 A1
(43) Pub. Date: Dec. 9, 2004

(54) Document output device, document output system, and document output method

(76) Inventor: Masaichi Sawada, Tokyo (JP)

Correspondence Address: MORRISON & FOERSTER LLP, 1650 TYSONS BOULEVARD, SUITE 300, MCLEAN, VA, 22102, US

(21) Appl. No.: 10/855,960

(22) Filed: May 28, 2004

(30) Foreign Application Priority Data
May 30, 2003 (JP) 2003-154014

(51) Int. Cl. G06F 15/00

(52) U.S. Cl. 358/1.15

(57) ABSTRACT

A printing device of a document output device prints an acceptance number, a user ID and a user name to the surface of the front side of a first output paper, and outputs it to a paper stacking unit. Then, the printing device outputs a second output paper that is printed based on received printing data, on the first output paper. The printing device further outputs a third output paper on the first and second output papers. A packing device of the document output device assembles the output papers stacked and output to the paper stacking unit, and packs the output papers with packing material.

### BACKGROUND OF THE INVENTION

1. Field of the Invention

The present invention relates to a document output device, a document output system, and a document output method.

2. Description of the Related Art

In recent years, the use of electronic files, that digitized documents and images, is increasing. There are cases where users who use electronic files want to carry out printing of electronic files, in an environment where a printing device (printer) can not be easily used. Therefore, in for example, Unexamined Japanese Patent Application KOKAI Publication No. 2003-67293, a method for a user to carry out printing of an electronic file, using a public printer placed at a convenience store or a print shop, is proposed.

In the method disclosed in Unexamined Japanese Patent Application KOKAI Publication No. 2003-67293, a user terminal and a plurality of printers are connected to a server via a network. In a case where a user wants to carry out printing of an electronic file at a predetermined convenience store (printer), the user operates the user terminal so as to send the electronic file that is to be printed, to the server, via the network. The server receives the electronic file, and transfers the electronic file to a predetermined printer. Then, by the user going to a predetermined convenience store, and operating the printer, printing of the electronic file is carried out. As a result, the user can obtain printed matter of the electronic file.

In the method disclosed in Unexamined Japanese Patent Application KOKAI Publication No. 2003-67293, the user goes to the placing site of the printer to operate the printer, and carries out printing of the electronic file. However, because printing is started after the user arrives at the placing site of the public printer, the user can not obtain the printing matter, immediately after he/she arrives at the placing site of the printer. Especially in a case where there are many pages to print, there are people who have arrived before the user and are using the printer, or there are people waiting in line to user the printer, the user has to wait a long time to obtain the printed matter. In this way, there are cases where the user can not effectively obtain the printed matter of the electronic file. It is possible to effectively obtain a printed matter by performing printing of an electronic file by the printer, before the user arrives. However, in this case, there is a risk of the printing content being seen by a third person.

### SUMMARY OF THE INVENTION

The present invention has been in consideration of the above, and the object of the present invention is to provide a document output device, a document output system, and a document output method, so that a printed matter can be effectively obtained, without the printing content being seen by a third person.

To achieve the above object, a document output device according to a first aspect of the present invention, is connected to a communication network, which carries out printing based on a printing request by a user, and outputs a document that is printed, comprising:

a reception unit that receives information concerning the printing request of the user, including user identification information that identifies the user and printing data that is a target of the printing request, via the communication network;

a first output unit that outputs a first output paper that has the user identification information received by the reception unit printed;

a second output unit that outputs a second output paper that has the printing data received by the reception unit printed, stacking the second output paper on the first output paper;

a third output unit that outputs a third output paper so that it is stacked on the second output paper, and

a packing unit that packs the first output paper, the second output paper, and the third output paper, in a stacked state.

According to this structure, the second output paper that has the printing data printed can be packed between the first output paper that has user identification information printed, and the third output paper. Therefore, the printing content of the second output paper (surface of the front side of the first paper and the surface of the back side of the last paper) being seen by a third person can be prevented. Also, by the user identification information, the user who requested printing can be confirmed.

The document output device may further comprise a determination unit that determines whether the printing data is printed to the surface of the back side of the last second output paper, or not, wherein the third output unit outputs the third output paper stacked on the second output paper, in a case where the determination unit determines that printing data is printed to the surface of the back side of the last second output paper.

According to this structure, in a case where it is determined that printing data is printed to the surface of the back side of the last second output paper, the second output paper that printed the printing data (request document) can be packed between the first output paper and the third output paper. In a case where a request document is not printed to the surface of the back side of the last second output paper, output of the third output paper can be changed. Therefore, the printing content of the surface of the front side of the first paper and the surface of the back side of the last paper of the second output paper, being seen by a third person can be prevented. Also, by the user identification information, the user who requested printing can be confirmed. Further, in a case where a request document is not printed to the surface of the back side of the last second output paper, unnecessary output of the third output paper can be prevented.

The document output device may further comprise at least either a tint block printing unit that prints tint blocks for blinding, on the first printing paper, or an additional paper output unit that outputs additional paper in between the first output paper and the second output paper. In this case, the printing content of the second output paper being seen through the first output paper can be prevented.

The document output device may further comprise at least either a unit that prints tint blocks for blinding to the third printing paper, or a unit that outputs additional paper in between the second output paper and the third output paper. In this case, the printing content of the second output paper being seen through the third output paper can be prevented.

The document output device, wherein:

the tint block printing unit may print tint blocks for blinding to the first printing paper, in a case where the printing data is printed to the surface of the back side of the last paper of the second output paper, and

the additional paper output unit may output additional paper in between the first output paper and the second output paper, in a case where the printing data is printed to the surface of the back side of the last paper of the second output paper. In this case, if the printing data is printed to the surface of the back side of the last second output paper, the printing content of the second output paper being seen through the third output paper can be prevented. Also, if the printing data is not printed to the surface of the back side of the last second output paper, unnecessary printing of tint blocks for blinding, and output of the third output paper can be prevented.

The document output device, wherein:

the first output paper may have the user identification information printed to the surface of the front side of the first printing paper;

the second output paper may have printing data printed to the second printing paper, and

the third printing paper may be used as the third output paper.

The document output device, wherein the first and third printing papers may have a different type of printing paper from the second printing paper.

The document output device, wherein the third output unit may output the third output paper that printed the user identification information to the surface of the front side. In this case, user identification can be confirmed from either surface of the packed output paper.

A document output system according to a second aspect of the present invention is connected to a communication network, which carries out printing based on a printing request by a user, and includes a document output device that outputs a document that is printed, wherein

the document output device, comprises:

a reception unit that receives information concerning the printing request of the user, including user identification information that identifies the user and printing data that is a target of the printing request;

a first output unit that outputs a first output paper that has the user identification information received by the reception unit printed;

a second output unit that outputs a second output paper that has the printing data received by the reception unit printed, stacking the second output paper on the first output paper;

a third output unit that outputs a third output paper so that it is stacked on the second output paper, and

a packing unit that packs the first output paper, the second output paper, and the third output paper, in a stacked state.

The document output system, further comprising a document output support server that is connected to the document output device, wherein

the document output support server may comprise:

a printing request reception unit that receives information concerning a printing request of a user sent from the user terminal of the user, via said communication network;

an acceptance information providing unit that provides acceptance information that accepted the printing request, to the information concerning the printing request of the user, received by the printing request reception unit, and

a sending unit that sends information concerning the printing request of the user, received by the printing request reception unit, and acceptance information provided by the acceptance information providing unit, to the document output device.

The document output system, wherein the document output support server may further comprise a document output device designation unit that has the user designate a document output device that outputs the printed document.

A document output method according to a third aspect of the present invention, carries out printing based on a printing request by a user, and outputs a document that is printed, comprising:

a reception step of receiving information concerning the printing request of the user, including user identification information that identifies the user and printing data that is a target of the printing request, via the communication network;

a first output step of outputting a first output paper that has the user identification information received by the reception step printed;

a second output step of outputting a second output paper that has the printing data received by the reception unit printed, stacking the second output paper on the first output paper;

a third output step of outputting a third output paper so that it is stacked on the second output paper, and

a packing step of packing the first output paper, the second output paper, and the third output paper, in a stacked state.

A document output method according to a fourth aspect of the present invention, carries out printing based on a printing request by a user, and outputs a document that is printed, comprising:

a reception step of receiving information concerning the printing request of the user, including user identification information that identifies the user, and printing data that is a target of the printing request, via the communication network;

a first output step of outputting a first output paper that has the user identification information received by the reception step printed;

a second output step of outputting a second output paper that has the printing data received by the reception step printed, stacking the second output paper on the first output paper;

a determination step of determining whether the printing data is printed on the surface of the back side of the last second output paper;

a third output step of outputting a third output paper so that it is stacked on the second output paper, in a case where it is determined that printing data is printed on the surface of the back side of the last second output paper, by the determination step, and

a packing step of packing the first output paper, the second output paper, and the third output paper, in a stacked state.

A computer readable recording medium according to a fifth aspect of the present invention, stores a program for functioning as a document output device that is connected to a communication network, carries out printing based on a printing request by a user, outputs a document that is printed, and controls a computer to function as:

a reception unit that receives information concerning the printing request of the user, including user identification information that identifies the user and printing data that is a target of the printing request, via the communication network;

a first output unit that outputs a first output paper that has the user identification information received by the reception unit printed;

a second output unit that outputs a second output paper that has the printing data received by the reception unit printed, stacking the second output paper on the first output paper;

a third output unit that outputs a third output paper so that it is stacked on the second output paper, and

a packing unit that packs the first output paper, the second output paper, and the third output paper, in a stacked state.

A computer readable recording medium according to a sixth aspect of the present invention, stores a program for functioning as a document output device that is connected to a communication network, carries out printing based on a printing request by a user, outputs a document that is printed, and controls a computer to function as:

a reception unit that receives information concerning the printing request of the user, including user identification information that identifies the user and printing data that is a target of the printing request, via the communication network;

a first output unit that outputs a first output paper that has the user identification information received by the reception unit printed;

a second output unit that outputs a second output paper that has the printing data received by the reception unit printed, stacking the second output paper on the first output paper;

a determination unit that determines whether the printing data is printed on the surface of the back side of the last second output paper;

a third output unit that outputs a third output paper so that it is stacked on the second output paper, in a case where the determination unit determines that printing data is printed on the surface of the back side of the last second output paper, and

a packing unit that packs the first output paper, the second output paper, and the third output paper, in a stacked state.

### BRIEF DESCRIPTION OF THE DRAWINGS

These objects and other objects and advantages of the present invention will become more apparent upon reading of the following detailed description and the accompanying drawings in which:

FIG. 1 is a diagram showing the structure of a document output system according to an embodiment of the present invention;

FIG. 2 is a diagram showing the structure of a document output support server in FIG. 1;

FIG. 3 is a diagram showing data stored in a user information storage unit;

FIG. 4 is a diagram showing data stored in an output destination information storage unit;

FIG. 5 is a diagram showing data stored in an acceptance information storage unit;

FIG. 6 is a diagram showing an outline of a document output device;

FIG. 7 is a diagram showing the structure of a printing device;

FIG. 8 is flowchart for describing a document output method;

FIG. 9 is a diagram showing an example of a search result screen, and

FIG. 10 is a flowchart for describing printing processing.

### DETAILED DESCRIPTION OF THE PREFERRED EMBODIMENT

An embodiment of the present invention will be described with reference to the drawings. In the present embodiment, the present invention will be described in a case of a document output system having a document output device, comprising a printing device and a packing device.

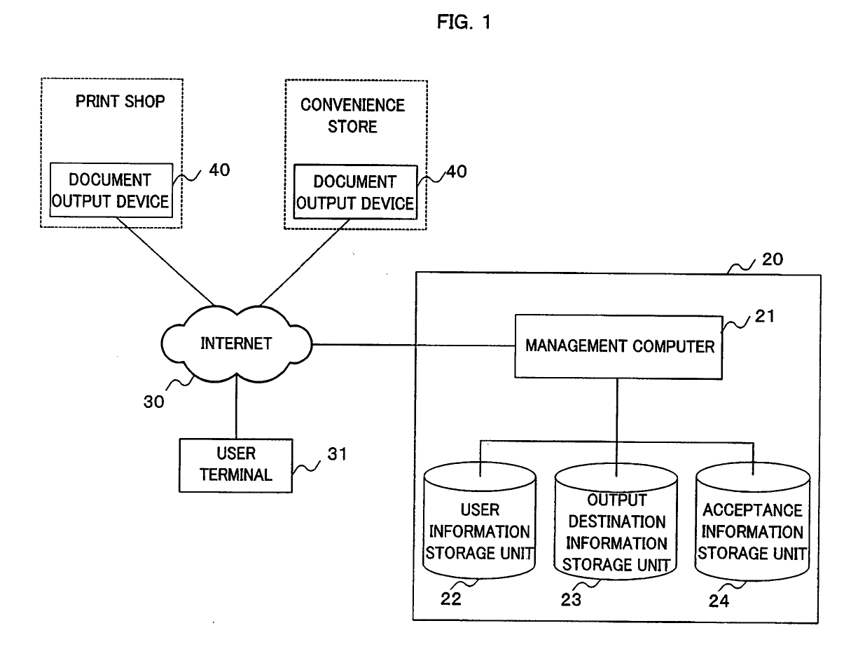

FIG. 1 shows a structure of a document output system of the present embodiment. As shown in FIG. 1, the document output system comprises a document output support server 20, the Internet 30 as a communication network, a user terminal 31 connected to the document output support server 20 via the Internet 30, and a document output device 40 connected to the document output support server 20 via the Internet 30.

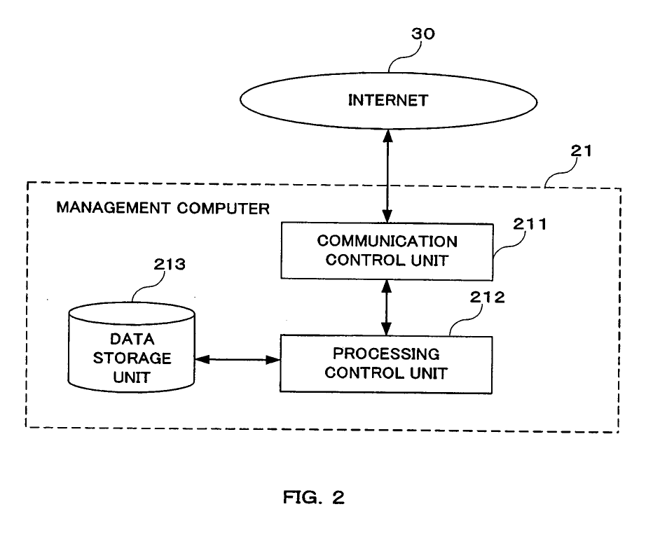

The document output support server 20 is for carrying out various processing concerning the document output system. The document output support server 20 comprises a management computer 2 1. FIG. 2 shows a structure of the management computer 2 1. As shown in FIG. 2, the management computer 21 comprises a communication control unit 211, a processing control unit 212, and a data storage unit 213.

The communication control unit 211 is constituted by a predetermined communication device, such as an NIC, or a router, and connects the document output support server 20 and the Internet 30. The communication control unit 211 carries out sending/receiving of various data (information) between the user terminal 31 and the document output device 40, via the Internet 30.

The processing control unit 212 carries out communication via the communication control unit 211, and processing of various information. The processing control unit 212 is constituted by, for example, a CPU (Central Processing Unit), a predetermined storage device (RAM (Random Access Memory, etc.)) that is to be a work area. The processing control unit 212 performs various processing based on operation programs read from the data storage unit 213.

The data storage unit 213 is constituted by a predetermined storage device, such as for example, a hard disk device, a ROM (Read Only Memory). Various operation programs executed by the processing control unit 212, various information, for example, information that structure various images displayed in each processing, various images of material for generating these images, and various forms, etc., are stored in the data storage unit 213.

A storage unit that stores various information concerning the document output system, is connected to the management computer 21. For example, a user information storage unit 22, an output destination information storage unit 23, and an acceptance information storage unit 23, are connected to the management computer 21. These storage units are constituted by a predetermined re-writable storage device, for example, such as a hard disk device.

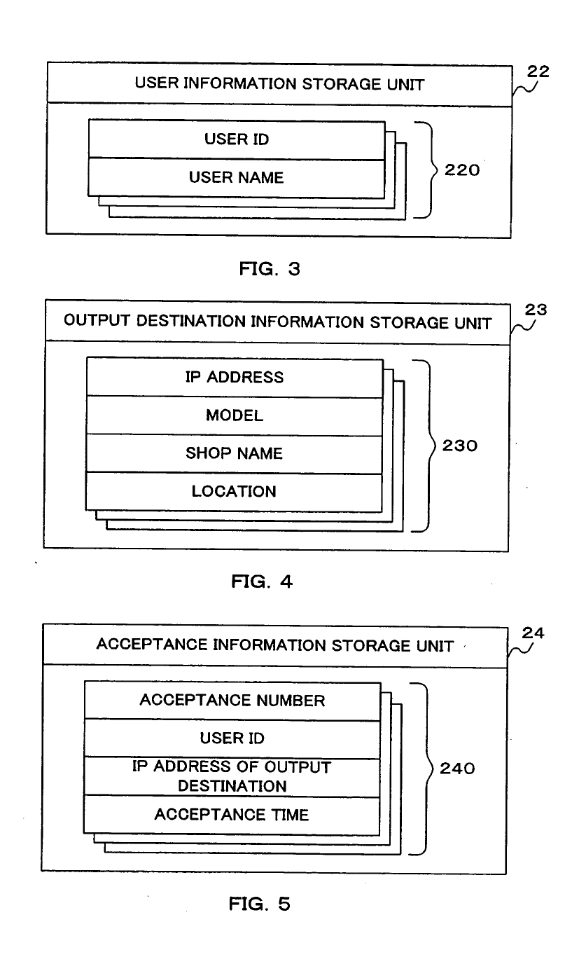

The user information storage unit 22 is a storage unit that stores user information concerning the users. For example, as shown in FIG. 3, user information 220 according to each user is stored in the user information storage unit 22. There is a user ID, a user name, and a password, etc., as user information 220. The user ID is an identifier for identifying users. The user name is the name of the user. The password is for the users to log-in to the document output system. The user information 220 is stored to the user information storage unit 22, in a case where it is registered that the service provided by the document output system will be used by the user. The user information 220 is stored before the processing of the present embodiment.

The output destination information storage unit 23 is a storage unit that stores output destination information concerning the document output device 40 placed at stores, such as print shops, and convenient stores, etc. For example, as shown in FIG. 4, output destination information 230 according to each document output device 40, is stored in the output destination information storage unit 23. There is an IP address, model, shop name, and location, etc., as output destination information 230. The IP address is an IP address in the Internet 30 of the document output device 40 placed at stores, such as print shops and convenience stores, etc. The model is the model of the document output device 40. The shop name is the name of the shop that places the document output device 40. The location is the location of the shop where the document output device 40 is placed. In the present invention, the latitude and longitude of the address of the shop is set as the location. The output destination information 230 is stored to the output destination information storage unit 23, in a case where it is registered that a representative of a shop that placed the document output device 40 will participate in the service that the document output system provides. The output destination information 230 is stored before the processing of the present embodiment.

The acceptance information storage unit 24 is a storage unit that stores acceptance information of a printing request of the user. For example, as shown in FIG. 5, acceptance information 240 is stored according to each accepted printing request, to the acceptance information storage unit 24. There is an acceptance number, a user ID, an IP address of an output destination, and an acceptance time, etc., as the acceptance information 240. The acceptance number is an identifier for identifying a printing request from the user. The user ID is an identifier for identifying the users. The IP address of the output destination is an IP address in the Internet 30 of the document output device 40 that performs printing. The acceptance time is the year, date, and time that the printing request is accepted (in the present embodiment, it is the year, date, and time that the later described selection data of the document output device 40 is received from the user terminal 31). The acceptance information 240 is stored in the acceptance information storage unit 24, in a case where selection data of the document output device 40 is received from the user terminal 31, and sent to the document output device 40, wherein the printing data is selected.

The Internet 30 is a communication network based on a predetermined communication protocol, such as for example, TCP/IP (Transmission Control Protocol/Internet Protocol). In the present embodiment, the present invention will be described with the Internet 30 as an example. However, the communication network may be for example, a LAN (Local Area Network) or a WAN (Wide Area Network) based on a predetermined communication protocol.

The user terminal 31 is constituted by a computer or a portable terminal, etc., that has communication functions. The user terminal 31 comprises for example, a control unit (CPU), a storage unit (RAM, ROM, hard disk, etc.), a communication unit, a display unit (for example, a monitor), and an input unit, etc., that are not shown in the drawings, and is used for printing request to the document output support server 20.

As shown in FIG. 1, the document output device 40 is placed at stores, such as print shops and convenience stores, etc. The document output device 40 is connected to the Internet 30, and has a specific IP address. In the present embodiment, by executing the document output program, the document output device 40 functions as a reception unit, a first output unit, a second output unit, a third output unit, and a packing unit, etc., and carries out processing for printing and packing output paper, etc. Namely, in the present embodiment, the document output device 40 comprises a reception unit, a first output unit, a second output unit, a third output unit, and a packing unit, etc.

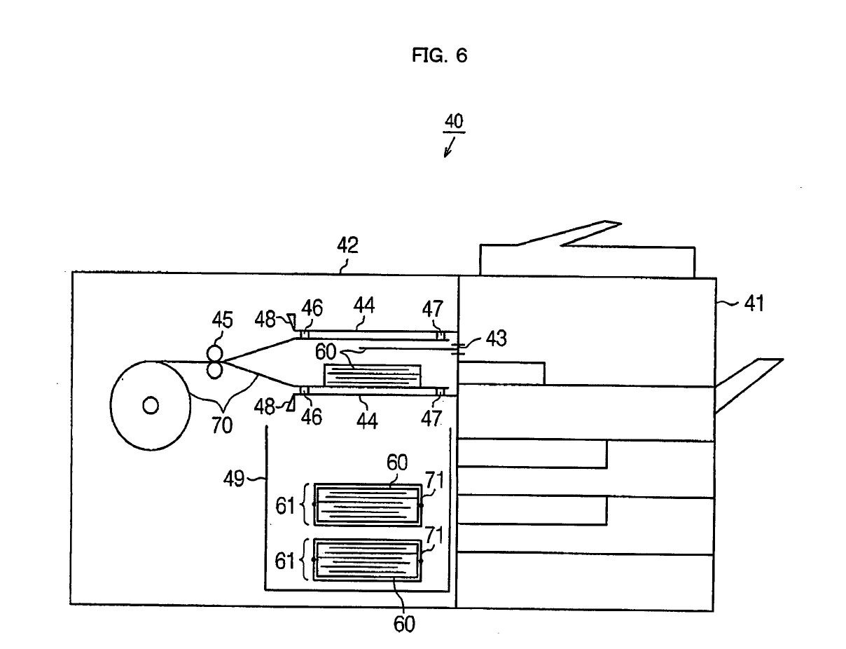

FIG. 6 shows an outline diagram of the document output device 40. As shown in FIG. 6, the document output device 40 comprises a printing device 41 and a packing device 42.

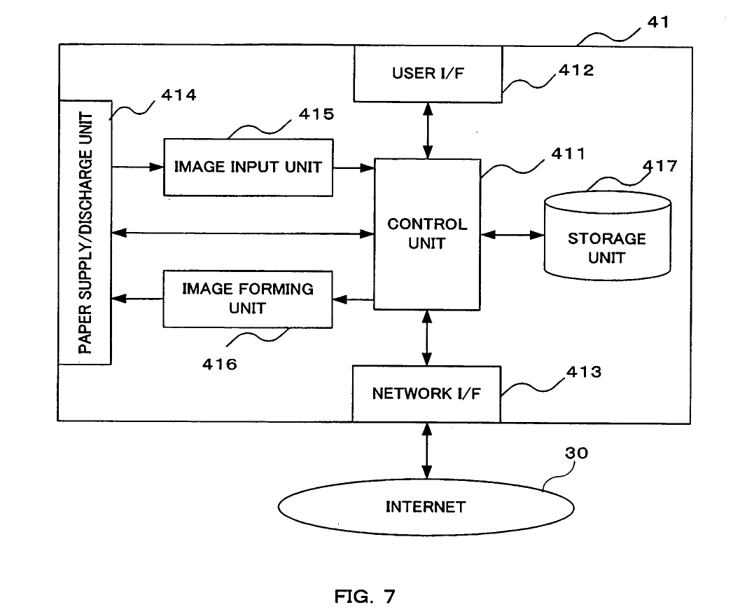

The printing device 41 is a printer or a complex machine that performs printing by receiving printing data from the document output support server 20. The structure of the printing device 41 is shown in FIG. 7.

As shown in FIG. 7, the printing device 41 comprises a control unit 411, a user interface (I/F) 412, a network interface (I/F) 413, a paper supply/discharge unit 414, an image input unit 415, an image forming unit 416, and a storage unit 417.

The control unit 411 is constituted by for example, a CPU or a predetermined storage device (for example, a RAM, a ROM), and controls each unit of the printing device 41.

The user interface 412 controls the input unit (for example, an operation panel) of the printing device 41, and carries out input and output of predetermined information to the control unit 411.

The network interface 413 is constituted by a predetermined communication device, and connects the printing device 41 and the Internet 30.

The paper supply/discharge unit 414 is constituted by, for example, an ADF (Auto Document Feeder), a sorter, a finisher, and an internal paper feeding mechanism, and carries out paper supply/discharge of manuscripts loaded by a copying function and paper output by the copying function and a printing function. The paper supply/discharge unit 414 discharges paper (output paper 60) to the inside of the packing material 70 spread in a later-described paper stacking unit 44 of the packing device 42, from a discharge opening 43.

The image input unit 415 is constituted by an optical reader, such as a scanner, and optical reads a manuscript loaded to the copying machine, to convert the manuscript to a predetermined image data.

The image forming unit 416 is constituted by, for example, a laser printer engine, etc., and carries out printing of documents, output from the copying function and the printing function.

The storage unit 417 is constituted by, for example, a re-writable storage device, such as a hard disk device, etc., and stores image data loaded by the copying function, and information obtained via the Internet 30. The storage unit 417 stores later-described tint blocks for blinding (for example, minute patterns), and printing data sent from the document output support server 20.

The packing device 42 packs paper (output paper 60) printed by the printing device 41. As shown in FIG. 6, the packing device 42 is placed on the side of the discharge opening 43 of the printing device 41. The packing device 42 comprises a packing unit that packs the output paper 60 in a state that the paper is stacked. In the present embodiment, the packing device 42 comprises a paper stacking unit 44, a pair of feed rollers 45, a pair of first heaters 46, a pair of second heaters 47, and a pair of cutters 48, as the packing unit. The packing device 42 also comprises a stock unit 49 that holds the packed output paper 60 (later-described package 61).

As shown in FIG. 6, the paper stacking unit 44 is placed at a position facing the discharge opening 43 of the printing device 41. The paper stacking unit 44 stacks the paper (output paper 60) printed by the printing device 41 and discharged from the discharge opening 43. The paper stacking unit 44 retains a packing material 70 that packs the output paper 60 discharged from the discharge opening 43. In the present embodiment, the packing material 70 is a tube-shaped vinyl, and is winded in a roll-shape. The packing material 70 is reeled out to the side of the discharge opening 43 of the paper stacking unit 44, and the fore-end of the packing material 70 is retained by the paper stacking unit 44, in a state that the fore-end is opened. Then, as will be later-described, the output paper 60 discharged from the side of the discharge opening 43 is supplied to the interior of the packing material 70 that is retained in a state that the fore-end is opened.

The pair of feed rollers 45 are placed between the paper stacking unit 44 and the roll-shaped packing material 70. The pair of feed rollers 45 pull out the roll-shaped packing material 70, and sends it into the paper stacking unit 44. The rotation of the feed rollers 45 is controlled by a not-shown feed roller control motor. On the side of the paper stacking unit 44 of the feed rollers 45, a pair of not-shown nozzles that face the packing material 70, by sandwiching the material, are fixed. Airflow can be passed through these nozzles. The fore-end of the packing material 70 is opened by the airflow passed through the nozzles, and the packing material 70 is sent through to the paper stacking unit 44, by the feed rollers 45. As a result, the packing material 70 is retained in a situation, as shown in FIG. 6. The mechanism of opening the fore-end of the packing material 70 (a tube-shaped bag material), by passing airflow through the nozzles, and sending the packing material 70 to the paper stacking unit 44 (tube material) is the same mechanism as disclosed in Unexamined Japanese Patent Application KOKAI Publication No.

H11-115908.

When setting the roll-shaped packing material 70 to the feed rollers 45, it is preferable that the fore-end portion of the packing material 70 is opened a little, and air is provided in the packing material 70. By providing air in the interior of the packing material 70, and setting it to the feed rollers 45, the packing material 70 can be opened more easily. This is thought to be that the air in the interior is accumulated, and operates so that the packing material 70 that passes through the feed rollers 45 opens. The feed rollers 45 are driven, and the roll-shaped packing material 70 is pulled out and sent to the interior of the paper stacking unit 44. Airflow is passed through from the nozzles, and the fore-end of the packing material 70 is opened. In a state that the fore-end of the packing material 70 is opened, the packing material 70 is transferred to the side of the discharge opening 43, along the inner wall surface of the paper stacking unit 44.

The pair of first heaters 46 are formed on the side of the feed rollers 45 of the paper stacking unit 44. The first heaters 46 are formed in a size, so that the entire width of the packing material 70 can be heated. The pair of first heaters 46 are structured to be transferable, so that the distance of the two heaters become close or spreads by a not-shown first heater transfer motor. Therefore, by heating the pair of first heaters 46, in a state that the packing material 70 is in between (sandwiched), the entire width of the packing material 70 can be bound. In the vicinity of the first heaters 46, a not-shown first suction unit is provided. The first suction unit retains the packing material 70 by suction. The first suction unit can be transferred, together with the first heaters 46.

The pair of second heaters 47 are formed on the side of the discharge opening 43 of the paper stacking unit 44. The second heaters 47 are formed in a size, so that the entire width of the packing material 70 can be heated. The pair of second heaters 47 are structured to be transferable, so that the distance of the two heaters become close or spreads by a not-shown second heater transfer motor. Therefore, by heating the pair of second heaters 47, in a state that the packing material 70 is in between (sandwiched), the entire width of the packing material 70 can be bound. In the vicinity of the second heaters 47, a not-shown second suction unit is provided. The second suction unit retains the packing material 70 by suction. The second suction unit can be transferred, together with the second heaters 47.

The pair of cutters 48 are formed on the side of the feed rollers 45 of the first heaters 46. The pair of cutters 48 can be moved to and from in a width direction (a direction that is orthogonal to the longitudinal direction) of the packing material 70. The cutting edge of the pair of cutters 48 are respectively inclined inwards. The pair of cutters 48 cut the packing material 70, by moving to the width direction of the packing material 70, in a state that the packing material 70 is sandwiched.

The stock unit 49 is a place for safekeeping the package 61 (the output paper 60 being packed by a bag 71 of the packing material 70). The stock unit 49 is placed near the paper stacking unit 44. In the present embodiment, the stock unit 49 is placed below the paper stacking unit 44. The stock unit 49 has an opening and closing part that leads to the exterior of the packing device 42. The opening and closing part is structured so that it can be opened and closed, by for example, an exclusive key. By opening the opening and closing part by the exclusive key, the package 61 kept in the stock unit 49 can be taken out. This key is kept by for example, a person in charge of the shop that places the document output device 40. The package 61 is transferred from the paper stacking unit 44 to the stock unit 49, by a not-shown transferring unit.

The series of operations in the packing device 42 are controlled by a control unit that the packing device 42 comprises. The control unit of the packing device 42 is connected to for example, the control unit 411 of the printing device 41, via a communication control unit, and controls each part of the packing device 42, based on the instructions from the control unit 411.

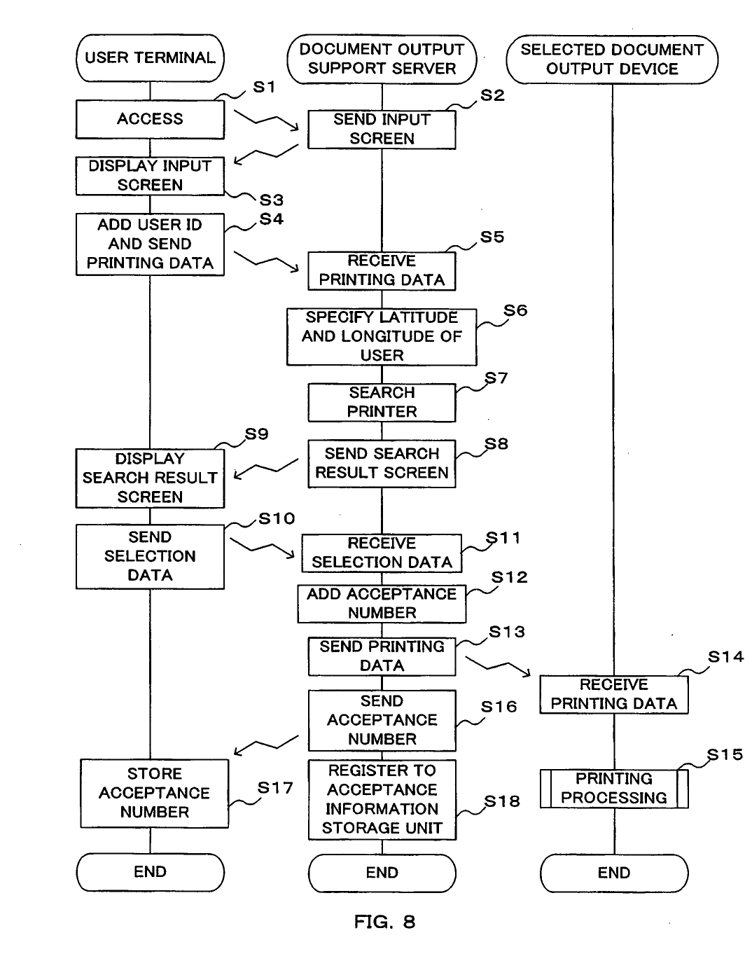

Next, a document output method applying a document output system, structured as above, will be described. In the present embodiment, a case where an electronic file is printed and packed by a predetermined document output device 40, based on a printing request from the user terminal 31, will be described with reference to the flowchart in FIG. 8.

First, the user operates the user terminal 31, accesses to for example, a Web site provided by the document output support server 20, via the Internet (step S1), and logs-in to the present system, by inputting a user ID and a password. In a case where the management computer 21 (control unit 212) of the document output support server 20 accepts that he/she is a user, from the ID and password, information of the input screen (for example information in HTML format) is read from the data storage unit 213, and sent to the user terminal 31 (step S2). The user terminal 31 that receives the information of the input screen, displays the received input screen to the display unit (step S3).

Next, the user specifies an electronic file that is a printing target, by operating the user terminal 31, and carries out a printing request of the specified electronic file. When the printing request is carried out by the user, the user terminal 31 converts the electronic file that is the printing target, to printing data, by for example, a printer driver. In the header of the printing data, a designation model, and a designation function, are included as setting information. The designation model is the model of the printer that completely corresponds to the printer driver that generated the printing data. The designation function is a function for performing the printing condition set by the printer driver. Designation of performing printing by duplex (both-side) printing or single-side printing, is included as the designation function. The user terminal 31 puts a user ID to that printing data, and sends it to the document output support server 20 (step S4).

Here, the user terminal 31 sends information concerning a present location of the user (user terminal 31), together with the printing data, to the document output support server 20. For example, in a case where a GPS function is installed to the user terminal 31, the user terminal 31 sends position information obtained by the GPS function, to the document output support server 20. In a case where a GPS function is not installed to the user terminal 31, the user terminal 31 displays an input screen for inputting the present location of the user, to the display unit, and has the user input the present location, and sends the input information concerning the present location, to the document output support server 20.

When the control unit 212 of the document output support server 20 receives printing data, etc. (step S5), it specifies the latitude and longitude of the user (sent from user terminal 31) (step S6). For example, in a case where the position information obtained by the GPS function is sent from the user terminal 31, the control unit 212 specifies the latitude and longitude of the user, based on the position information. In a case where information concerning the present position is sent from the user terminal 31, the control unit 212 specifies the latitude and longitude of the present location of the user, based on information concerning the present location.

Then, the control unit 212 searches a document output device 40 that can carry out printing, within a predetermined distance from the present location of the user (step S7). Concretely, the control unit 212 extracts document output devices 40 that are placed within a predetermined distance from the present location of the user, based on the latitude and longitude of the location of the document output device 40 of the output destination information 230 stored in the output information storage unit 23, and the latitude and longitude of the present location of the user. Sequentially, the control unit 212 extracts a document output device 40 that can print the received printing data of the extracted document output devices 40. As the document output device 40 that can carry out printing, there is a type of document output device 40 that can carry out printing using the received printing data, and there is a type of document output device 40 that can carry out printing, by converting the printing data. The control unit 212 specifies a document output device 40 that can carry out printing, by determining whether the model of the output destination information 230 of each document device 40 and the designation model set in the header of the printing data, are the same model, or can be corresponded by converting the printing data.

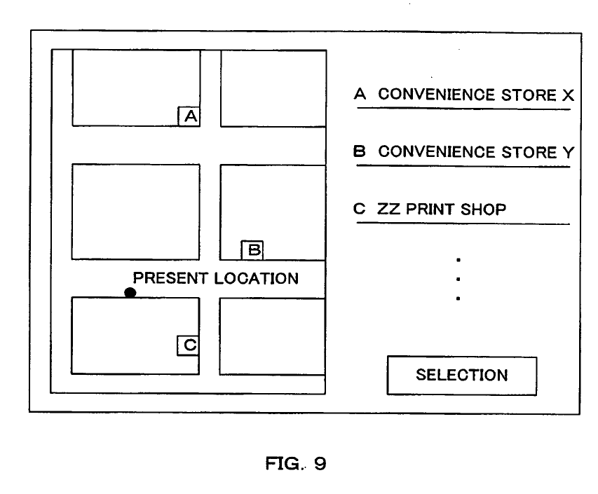

Then, the control unit 212 creates information (for example, information in HTML format) of a search result screen, for example, such as shown in FIG. 9, based on the information stored in the output destination information storage unit 23, etc., and sends the information of the created search result screen to the user terminal 31 (step S8). A map near the present location of the user, and a list of shop names that place the searched document output device 40, etc., are displayed in the search result screen shown in FIG. 9. The present location of the specified user, and the location of the shop that places the searched document output device 40, are displayed in the map near the present location of the user. A selection button is provided in the search result screen. By clicking the selection button, after a predetermined document output device 40 is clicked, a document output device 40 for performing printing, can be selected. Functions of each document output device 40, whether designation function of the printing data can be used, and usage functions, etc., in a case where functions can be corresponded, by using another function instead of that function, etc., may be displayed.

The user terminal 31 that received information of the search result screen, displays the search result screen shown in FIG. 9, to the display unit (step S9). For example, in a case where the user selects the document output device 40 of shop A (convenience store X), the user clicks the “selection button” after clicking shop A. The user terminal 31 sends the selection data, including user ID, to the document output support server 20 (step S10).

The control unit 212 receives the selection data, etc. (step S11), and provides an acceptance number (step S12). Then, the control unit 212 sends the printing data, adding an acceptance number as information that identifies a user, a user ID, and a user name, to the IP address of the selected document output device 40 (step S13).

Here, in a case where it is necessary to convert the printing data concerning the selected document output device 40, the control unit 212 converts the printing data to printing data that corresponds to the selected document output device 40. In a case where printing data is converted, the control unit 212 sends the converted printing data.

When receiving the acceptance number, printing data that has added a user ID and a user name, (step S14), the document output device 40 (control unit 411) stores the received printing data and acceptance number, and user ID and user name to the storage unit 417, and carries out the later-described printing processing (step S15).

The control unit 212 sends information concerning the acceptance number, to the user terminal 31 (step S16). The user terminal 31 that receives the acceptance number, displays the acceptance number and stores the number to the storage unit (step S17). This acceptance number is used for user certification, when receiving printed matters of the electronic file.

The control unit 212 registers the acceptance number and user ID added to the printing data, and the IP address of the document output device 40 that printing data is sent, to the acceptance information storage unit 24 (step S18). Concretely, the control unit 212 registers the acceptance number and user ID added to the printing data, and the IP address of the document output device 40 that printing data is sent, to the acceptance information storage unit 24, as the acceptance number, user ID, and IP address of output destination, of the acceptance information 240. The control unit 212 registers the data and time that the selection data is received, as the acceptance time of the acceptance information 240.

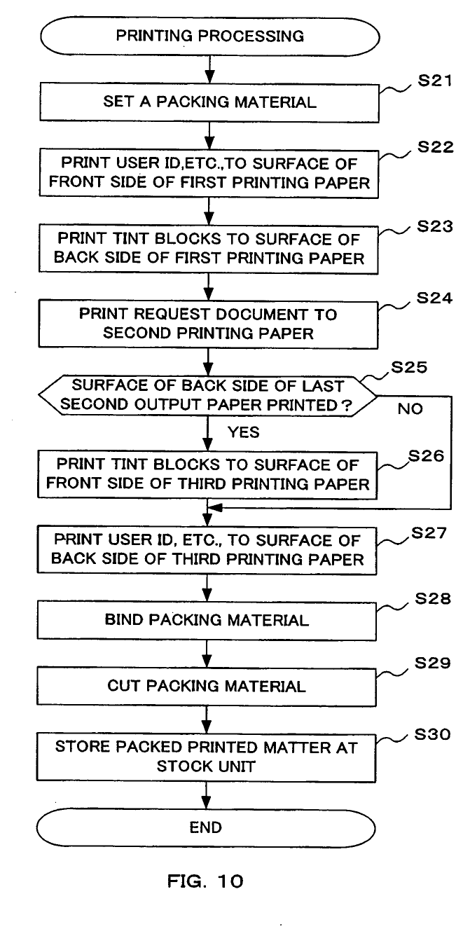

Next, printing processing by the document output device 40 that received the printing data, will be described with reference to the flowchart in FIG. 10. In the present embodiment, operation of each unit that constitutes the document output device 40 (printing device 41 and packing device 42) is controlled by a control unit 411 of the printing device 41. Operation of each unit that constitutes the packing device 42 is controlled by a not-shown control unit of the packing device 42, based on instructions from the control unit 411 of the printing device 41.

First, the document output device 40 sets the packing material to a predetermined position (step S21). Concretely, when the document output device 40 receives printing data, the control unit 411 of the printing device 41 sends information that the packing material will be set to a predetermined position, to the control unit of the packing device 42. The control unit of the packing device 42 that receives this information, drives the feed rollers 45 by a feed roller control motor (not-shown), and sends out the packing material 70 to the side of the paper stacking unit 44, by the feed rollers 45. The control unit of the packing device 42 controls airflow to pass through the nozzles, and as described above, opens the fore-end of the packing material 70 that is sent out. Therefore, the packing material 70, that is in a state that the fore-end is opened, is sent out to the side of the discharge opening 43, along the inner wall surface of the paper stacking unit 44.

When the fore-end of the packing material 70 is sent out to a position that contacts the second heaters 47, by the feed roller control motor, the control unit of the packing device 42 stops the feed rollers 45, by stopping the feed roller control motor. Next, the control unit of the packing device 42 drives the first suction unit at the side of the first heaters 46, and the second suction unit at the side of the second heaters 47, and controls the first suction unit and the second suction unit to respectively suck in the packing material 70. By this, the packing material is set to a predetermined position. The control unit of the packing device 42 sends information that the setting of the packing material is completed, to the control unit of the printing device 41.

When the control unit 411 of the printing device 41 receives information that setting of the packing material is completed, it controls the paper supply/discharge unit 414 and the image forming unit 416, and prints the acceptance number, user ID and user name stored in the storage unit 417 to a front side surface of a first printing paper (step S22). The first printing paper is printing paper used for printing the output paper 60 that is output first, in accordance with the printing request from the user.

Here, duplex printing is possible by the printing device 41, and output paper 60 discharged from the discharge opening 43 is discharged (output) to the paper stacking unit 44, so that the front side surface of the paper is facing downwards. In a case where a plurality of output papers 60 are output by the printing device 41, the output papers 60 that are output, are stacked. Therefore, in the stacked output papers 60, the surface facing downwards of the lowest part becomes the front side surface of the output paper 60 output first, and surface facing upwards of the highest part becomes the back side surface of the output paper 60 output last.

Next, the control unit 411 of the printing device 41 reads the tint blocks for blinding stored in the storage unit 417, and controls the paper supply/discharge unit 414 and image forming unit 416, so as to print the read tint blocks for blinding to the back side surface of the first printing paper (step S23). In the present embodiment, minute patterns are printed as the tint blocks for blinding. After printing the front side and back side surface of the first printing paper, the control unit 411 of the printing device 41 controls the paper supply/discharge unit 414, and discharges the printed first printing paper to the paper stacking unit 44, from the discharge opening 43. The discharged first printing paper constitutes the first output paper.

The control unit 411 of the printing device 41, reads the printing data stored in the storage unit 417, and controls the paper supply/discharge unit 414 and the image forming unit 416 to print the document requested to be printed (request document) to a second printing paper (step S24). The second printing paper that has the request document printed, constitutes a second output paper. When the control unit 411 of the printing device 41 performs printing to the second printing paper, the control unit 411 controls the paper supply/discharge unit 414 to discharge the printed second printing paper from the discharge opening 43 to the paper stacking unit 44. By this, the printed second output paper is discharged so that it is stacked on the first output paper in the paper stacking unit 44. The control unit 411 of the printing device 41 prints an amount determined by the printing data, and discharges the printed second printing paper from the discharge opening 43 to the paper stacking unit 44. In the present embodiment, the same kind of printing paper as the first printing paper is used as the second printing paper. Therefore, in the present embodiment, the second printing paper is supplied by the paper supplying tray that supplied the first printing paper.

When printing a request document in step S24, both the duplex printing and the single-side printing are possible. The control unit 411 of the printing device 41, performs printing of the request document, in accordance with a designation of either a single-side printing or a duplex printing, set in the header of the printing data stored in storage unit 417.

Next, the control unit 411 of the printing device 41 determines whether the surface of the back side of the last second output paper (the surface facing upwards of the uppermost part in the paper stacking unit 44) is printed or not (step S25). Concretely, the control unit 411 of the printing device 41 determines whether the surface of the back side of the last second output paper is printed or not, based on printing data stored in the storage unit 417. For example, the control unit 411 of the printing device 41 determines whether the surface of the back side of the last output paper 60, that printed the request document, is printed or not, by the printing data.

In a case where the control unit 411 of the printing device 41 determines that the back side of the last second output paper is not printed, (step S25; NO), the flow forwards to step S27. In a case where the control unit 411 of the printing device 41 determines that the back side of the last second output paper is printed, (step S25; YES), the control unit 411 reads the tint blocks for blinding stored in the storage unit 417, and controls the paper supply/discharge unit 414 and the image forming unit 416, to print the read tint bocks to the front side surface of a third printing paper (step S26). In the present embodiment, minute patterns are printed as tint blocks for blinding. In this way, in a case where the surface of the back side of the last second output paper is printed, i.e., in a case where the printing content can be seen from the back side of the last second output paper, the tint blocks for blinding are printed. In a case where the surface of the back side of the last second output paper is not printed, i.e., in a case where the printing content can not be seen from the back side of the last second output paper, the tint blocks for blinding are not printed. By this, unnecessary tint blocks for blinding are not printed, and as a result, wasteful consumption of toners, etc., by carrying out printing of the tint blocks for blinding, can be prevented, and effective printing in accordance with the request document can be carried out. Here, the third printing paper is printing paper used in printing the output paper 60 after outputting the output paper 60 that printed the request document. In the present embodiment, the same kind of printing paper as the first and second printing papers, is used as the third printing paper. Therefore, in the present embodiment, the third printing paper is supplied by the paper supplying tray that supplied the first printing paper and the second printing paper.

Next, the control unit 411 of the printing device 41, controls the paper supply/discharge unit 414 and the image forming unit 416 to print the acceptance number, user ID and user name stored in the storage unit 417, to the back side of the third printing paper (step S27). After printing the surface of the back side of the third printing paper, the control unit 411 of the printing device 41 controls the paper supply/discharge unit 414 to discharge the printed third printing paper from the discharge opening 43 to the paper stacking unit 44. The discharged third printing paper constitutes the third output paper.

The output paper 60 (third output paper) is stacked on the output paper 60 (second output paper) stacked on the paper stacking unit 44, with the back side surface facing up. Therefore, the output paper 60 stacked on the paper stacking unit 44, whose surface is facing upwards, is the surface that has the acceptance number, user ID and user name printed. By this, printing ends.

When printing ends, the control unit 411 of the printing device 41 packs the printed matter, and sends information that the packed matter will be stored in the stock unit 49 of the packing device 42, to the control unit of the packing device 42. The control unit of the packing device 42 that receives this information controls each part of the packing device 42, as below, based on instructions from the control unit 411 of the printing device 41.

The control unit of the packing device 42 carries out processing for binding the packing material (step S28). Concretely, the control unit of the packing device 42 binds the packing material 70, by driving the first heater transfer motor to bring the first heaters 46 close to each other and heating them. Sequentially, the control unit of the packing device 42 binds the packing material 70, by driving the second heater transfer motor to bring the second heaters 47 close to each other and heating them. The control unit of the packing device 42 stops suction by the second suction unit, and drives the second heater transfer motor to alienate the second heaters 47.

Next, the control unit of the packing device 42 carries out processing for cutting the packing material (step S29). Concretely, the control unit of the packing device 42 transfers the cutters 48 by driving the cutter drive motor, and cuts the part bound by the first heaters 46 of the packing material 70, at the side of the feed rollers 45. By this, the bag 71 that has output paper 60 enclosed, is cut off from the roll-shaped packing material 70. Then, the control unit of the packing device 42 stops suction by the first suction unit, and drives the first transfer motor to alienate the first heaters 46.

Sequentially, the control unit of the packing device 42 stores the packed output paper 60 to the stock unit 49 (step S30). Concretely, the control unit of the packing device 42 transfers the package 61 from the paper stacking unit 44 to the stock unit 49 by the transfer unit. By this, the package 61 is stored in the stock unit 49. Then, the control unit of the packing device 42 sends information that packing has been completed, to the control unit 411 of the printing device 41. By this, printing processing ends.

When printing processing ends, the document output device 40 can carry out a new printing processing, in accordance with a next printing request. In a case where the document output device 40 has already received a next printing request, it starts printing processing in accordance with that printing request.

After the printing processing as above is carried out, the user can get the printed matter of the electronic data, by going to the shop where the selected document output device 40 is placed. The user tells the user ID and acceptance number to the store person of the shop, and requests the package 61 to be taken out. The store person uses an exclusive key for the opening and closing part of the stock unit 49, to open the opening and closing part of the stock unit 49, checks the user ID and acceptance number told by the user and the user ID and acceptance number printed on the surface outside the package 61, and takes out the package 61 that matches, from the stock unit 49 of the document output device 40. Then, the store person hands the extracted package 61 to the user, for example, by exchanging it with the fee for printing. By this way, the printing content of the printed matter of the electronic file is not seen by a third person. Also, because printing of the electronic file is completed, when the user goes to the shop, the printed matter can be obtained efficiently.

As described above, according to the present embodiment, the printed matter is packed by the bag 71 by the packing material 70, in a state that the second output paper that has the request document printed, is stacked between the first output paper and the third output paper. Therefore, the printing content of the second output paper, does not become seen by a third person, by the first output paper and the third output paper. Especially, even in a case where duplex printing is carried out to the second output paper, the surface of the back side of the last second output paper does not become seen by a third person. Also, because the printing content of the second output paper does not become seen by a third person, printing can be started before the user arrives at the placing site of the document output device 40. Therefore, printing matter can be effectively obtained, without the printing content being seen by a third person.

According to the present embodiment, because an acceptance number, a user ID and a user name are printed on the surface of the front side of the first output paper, the acceptance number, etc., can be confirmed from the outside of the package 61, and the user who requested printing can be easily confirmed, without opening the package 61. Further, according to the present embodiment, because an acceptance number, a user ID and user name are also printed on the surface of the back side of the third output paper, the acceptance number, etc., can be confirmed from either surfaces of the package 61.

According to the present embodiment, because the package 61 is stored in the stock unit 49 that has an opening and closing part that can be opened and closed by an exclusive key, the package 61 can be prevented from being taken away by a third person.

According to the present embodiment, because in a case where the surface of the back side of the last second output paper is not printed (the printing content of the second output paper can not be seen from the side of the third output paper), tint blocks for blinding are not printed to the surface of the front side of the third output paper, and effective printing in accordance with the request document can be carried out.

According to the present embodiment, because a document output device 40 in a predetermined range from the present location of the user is searched, and the user selects a certain document output device 40 from the search result, a document output device 40 near the present location of the user can be easily selected.

The present invention is not limited to the above embodiment, and various embodiments and changes are possible. Below, other embodiments that can be applied to the present invention will be described.

In the above embodiment, the present invention is described, in a case where tint blocks for blinding are printed on the side opposite to the surface that has the acceptance number, etc., printed, concerning the output paper 60 (the first and third output papers) that sandwiches the output paper 60 (second output paper) that prints the request document. However, the tint blocks for blinding may be printed on the same surface as the surface that has the acceptance number, etc., printed. Or, the tint blocks for blinding may be printed on both the surface that has the acceptance number, etc., of the output paper 60 printed, and the surface opposite to that surface.

In the above embodiment, the present invention is described, in a case where tint blocks for blinding are printed to the output papers 60 (first output paper and third output paper) that output before and after the output paper 60 that prints the request document, so that the printing content of the request document is not transparent. However, as long as the printing content can be hidden, it does not have to be tint blocks, and for example, an additional paper may be sandwiched in between the output paper 60 that prints the request document and the output paper 60 that prints the acceptance number, etc. The additional paper may be singular or plural. By sandwiching an additional paper (s), the printing content of the request document being transparent, can be prevented.

In the above embodiment, the present invention is described, in a case where tint blocks for blinding are printed on the surface of the front side of the third printing paper, when the surface of the back side of the last second output paper is printed. However, tint blocks for blinding may be printed for example, to the surface of the front side of the third printing paper, despite whether the surface of the back side of the last second output paper is printed or not.

In the above embodiment, the present invention is described, in a case where it is determined whether the surface of the back side of the last second output paper is printed or not, based on the printing data stored in the storage unit 417. However, it may be determined by a duplex printing or a single-side printing being designated. In this case, it can be determined by a duplex printing or a single-side printing being designated in the header of the printing data.

In a case where an additional paper (s) is sandwiched so that the printing content of the request document can not be seen, when the surface of the back side of the last second output paper is not printed, the additional paper (s) does not have to be sandwiched. In a case where the surface of the back side of the last second output paper is not printed, the number of additional papers may be made less than when the surface of the back side of the last second output paper is printed. By this, wasteful use of additional paper can be prevented.

In the above embodiment, the present invention is described, in a case where user identification information such as acceptance number, etc., is printed to the output paper 60, as the third output paper. However, the user identification information does not have to be printed to the third output paper.

In the above embodiment, the present invention is described, in a case where the same kind of output paper 60 that prints the request document is used as the output paper 60 that prints the acceptance number, etc. However, the printing paper that has the acceptance number, etc., printed, may be for example, a different kind as the output paper 60 that has the request document printed. In this case, a different kind of printing paper is set in a paper supply tray different from the paper supply tray that sets the output paper 60, and in a case where printing of an acceptance number, etc., is carried out, paper is supplied from the other paper supply tray. Here, it is preferable that a kind of printing paper, whose printing content of the stacked output paper 60 does not become transparent, is used as the another kind of printing paper that prints the acceptance number, etc. By doing so, the printing content being seen by a third person can be prevented. Also, a cardboard may be used as the another kind of printing paper. In this case, the output paper 60 that prints the request document can be packed in a state that the output paper 60 is reinforced, and bending, etc., of the output paper 60 that printed the request document, can be prevented.

In the above embodiment, the present invention is described, in a case where the output paper 60 is packed by a tube-shape packing material 70 whose entirety is transparent. However, the packing material 70 may be a material where one part is transparent, and the other parts are material that the interior is not transparent, and can not be seen. In this case, it is preferable that the acceptance number, etc., of the output paper 60 are printed so that they can be seen from the transparent part of the packing material 70. In this way, by using material that doesn't make the interior transparent, as the packing material 70, the request document can be packed so that the printing content is not transparent.

In the above embodiment, the present invention is described, in a case where an acceptance number, a user ID, and a user name are printed as the user identification information. However, the user identification information may be information that can identify the user, such as for example, the address, name, and telephone number, etc., of the user. Or, the user may select which information to use, as the user identification information to be printed. In this case, for example, when the user does not prefer to print the user's name, etc., the name, etc., are not printed, and the user's needs can be met.

In the above embodiment, the present invention is described, in a case where an acceptance number, a user ID and a user name are printed as the user identification information, and the user goes to the placing site of the document output device 40 to accept the package 61. However, the package 61 that is printed and packed, may be sent to a predetermined place. In this case, for example, a sending destination (for example, zip code, address), receiver (for example, user name), and a telephone number, etc., are printed as the user identification information. By this, it is possible to send the package 61 to the user, and it is not necessary for the user to go get the package 61 to the placing site of the document output device 40.

In the above embodiment, the present invention is described, in a case where the output paper 60 is packed using packing material 70 of tube-shaped vinyl. However, the output paper 60 may be packed by using another packing material. For example, a packing material that is in a bag shape in advance, may be used.

In the above embodiment, the present invention is described, in a case where the packing material 70 is used for packing the output paper 60. However, the output paper 60 may be packed by the first printing paper and the third printing paper, without using the packing material 70. In this case, the acceptance number, etc., are printed to the first and third printing papers using paper that has a material so that the printing content of the output paper 60 is not transparent, and can not be seen, and the output paper 60 that printed the request document is packed using those papers as the packing material.

In the above embodiment, the present invention is described, in a case where printing data generated in the printer driver comprised by the user terminal 31 is sent to the document output support server 20, and the document output support server 20 sends printing data based on that printing data or a printing data converted based on that printing data, to the document output device 40. However, for example, electronic data before being converted by the printer driver may be sent to the document output support server 20, and the electronic data may be converted to printing data using a printer driver that the document output support server 20 or the document output device 40 comprises. For example, the document output support server 20 may provide a web page for inputting printing conditions, and setting of the print driver may be carried out based on the printing conditions input by the user terminal 31. By this, it is not necessary for the user terminal 31 to comprise a printer driver adequate for each document output device 40, and the range of selection of document output devices widen.

In the above embodiment, the present invention is described, in a case where document output devices 40 in a predetermined range from the present location of the user is searched, and the user selects the document output device 40 to request printing from the search result. However, it may be that for example, the user operates the user terminal 31 to input conditions, such as near the destination of user, or near the station, etc., the document output support server 20 searches document output devices 40 that meet the conditions, and the user selects a document output device 40 to request printing, from the search result. Or, the user may operate the user terminal 31, and carry out a printing request directly to a specific document output device 40.

In the above embodiment, the present invention is described, by an embodiment, in a case where operation of each part that constitutes the packing device 42 is controlled based on the instructions from the control unit 411 of the printing device 41. However, operation of each part that constitutes the packing device 42 may be controlled by the control unit of the packing device 42.

In the above embodiment, the present invention is described, by an embodiment, in a case where the document output device 40 is a public document output device placed at convenience stores, etc. However, the document output device 40 does not have to be a public document output device. For example, the printer as the document output device may be placed in a building of a company, and may be used by certain users such as company members, etc.

The document output support server 20 according to the present invention can be realized using an ordinary computer system, without a need for a dedicated system. For example, the document output support server that performs the above processing can be structured, by installing a program, from a recording medium (a flexible disk, a CD-ROM, etc.,) that stores the program for executing the above processing.

Means for providing these programs are arbitrary. The programs can be supplied via a predetermined recording medium, such as above, or by for example, via a communication line, a communication network, or a communication system. In this case, for example, the program may be provided by being posted on a BBS of a communication network, and embedded on a carrier wave via a network. Then, by running the program provided in this way under the control of an OS, in the same way as other application programs, the processing of above can be executed.

According to the present invention, printing matters can be effectively obtained, without the printing content being seen by a third person.

Various embodiments and changes may be made thereonto without departing from the broad spirit and scope of the invention. The above-described embodiments are intended to illustrate the present invention, not to limit the scope of the present invention. The scope of the present invention is shown by the attached claims rather than the embodiments. Various modifications made within the meaning of an equivalent of the claims of the invention and within the claims are to be regarded to be in the scope of the present invention.

This application is based on Japanese Patent Application No. 2003-154014 filed on May 30, 2003 and including specification, claims, drawings and summary. The disclosure of the above Japanese Patent Application is incorporated herein by reference in its entirety.

What is claimed is:

1. A document output device that is connected to a communication network, which carries out printing based on a printing request by a user, and outputs a document that is printed, comprising:
a reception unit that receives information concerning the printing request of the user, including user identification information that identifies said user, and printing data that is a target of said printing request, via said communication network;
a first output unit that outputs a first output paper that has the user identification information received by said reception unit printed;
a second output unit that outputs a second output paper that has the printing data received by said reception unit printed, stacking the second output paper on the first output paper;
a third output unit that outputs a third output paper so that it is stacked on the second output paper, and
a packing unit that packs the first output paper, the second output paper, and the third output paper, in a stacked state.

2. The document output device according to claim 1, further comprising a determination unit that determines whether said printing data is printed to the surface of the back side of the last second output paper, or not, wherein said third output unit outputs the third output paper stacked on the second output paper, in a case where the determination unit determines that printing data is printed to the surface of the back side of the last second output paper.

3. The document output device according to claim 1, further comprising at least either a tint block printing unit that prints tint blocks for blinding on the first printing paper, or an additional paper output unit that outputs additional paper in between the first output paper and the second output paper.

4. The document output device according to claim 3, further comprising at least either a unit that prints tint blocks for blinding to the third printing paper, or a unit that outputs additional paper in between the second output paper and the third output paper.

5. The document output device according to claim 3, wherein:
said tint block printing unit prints tint blocks for blinding to the first printing paper, in a case where said printing data is printed to the surface of the back side of the last paper of the second output paper, and
said additional paper output unit outputs additional paper in between the first output paper and the second output paper, in a case where said printing data is printed to the surface of the back side of the last paper of the second output paper.

6. The document output device according to claim 1, wherein:
said first output paper has the user identification information printed to the surface of the front side of the first printing paper;
said second output paper has printing data printed to the second printing paper, and
the third printing paper is used as said third output paper.

7. The document output device according to claim 6, wherein said first and third printing papers have a different type of printing paper from the second printing paper.

8. The document output device according to claim 1, wherein said third output unit outputs the third output paper that printed said user identification information to the surface of the front side.

9. A document output system that is connected to a communication network, which carries out printing based on a printing request by a user, and includes a document output device that outputs a document that is printed, wherein
said document output device, comprises:
a reception unit that receives information concerning the printing request of the user, including user identification information that identifies said user, and printing data that is a target of said printing request, via said communication network;
a first output unit that outputs a first output paper that has the user identification information received by said reception unit printed;
a second output unit that outputs a second output paper that has the printing data received by said reception unit printed, stacking the second output paper on the first output paper;
a third output unit that outputs a third output paper so that it is stacked on the second output paper, and
a packing unit that packs the first output paper, the second output paper, and the third output paper, in a stacked state.

10. The document output system according to claim 9, further comprising a document output support server that is connected to the document output device, wherein
said document output support server comprises:
a printing request reception unit that receives information concerning the printing request of the user sent from the user terminal of said user, via said communication network;
an acceptance information providing unit that provides acceptance information that accepted the printing request, to the information concerning the printing request of the user, received by said printing request reception unit, and
a sending unit that sends information concerning the printing request of the user, received by the printing request reception unit, and the acceptance information provided by said acceptance information providing unit, to said document output device.

11. The document output system according to claim 10, wherein said document output support server further comprises a document output device designation unit that has the user designate a document output device that outputs the printed document.

12. A document output method, which carries out printing based on a printing request by a user, and outputs a document that is printed, comprising:
a reception step of receiving information concerning the printing request of the user, including user identification information that identifies said user, and printing data that is a target of said printing request, via a communication network;
a first output step of outputting a first output paper that has the user identification information received by said reception step printed;
a second output step of outputting a second output paper that has the printing data received by said reception step printed, stacking the second output paper on the first output paper;
a third output step of outputting a third output paper so that it is stacked on the second output paper, and
a packing step of packing the first output paper, the second output paper, and the third output paper, in a stacked state.

13. A document output method that carries out printing based on a printing request by a user, and outputs a document that is printed, comprising:
a reception step of receiving information concerning the printing request of the user, including user identification information that identifies said user, and printing data that is a target of said printing request, via a communication network;
a first output step of outputting a first output paper that has the user identification information received by said reception step printed;
a second output step of outputting a second output paper that has the printing data received by said reception step printed, stacking the second output paper on the first output paper;
a determination step of determining whether said printing data is printed on the surface of the back side of the last second output paper;
a third output step of outputting a third output paper so that it is stacked on the second output paper, in a case where he determination step determines that printing data is printed on the surface of the back side of the last second output paper, and
a packing step of packing the first output paper, the second output paper, and the third output paper, in a stacked state.

14. A computer readable recording medium that stores a program for functioning as a document output device that is connected to a communication network, carries out printing based on a printing request by a user, outputs a document that is printed, and controls a computer to function as:
a reception unit that receives information concerning the printing request of the user, including user identification information that identifies said user, and printing data that is a target of said printing request, via said communication network;
a first output unit that outputs a first output paper that has the user identification information received by said reception unit printed;
a second output unit that outputs a second output paper that has the printing data received by said reception unit printed, stacking the second output paper on the first output paper;
a third output unit that outputs a third output paper so that it is stacked on the second output paper, and
a packing unit that packs the first output paper, the second output paper, and the third output paper, in a stacked state.

15. A computer readable recording medium that stores a program for functioning as a document output device that is connected to a communication network, carries out printing based on a printing request by a user, outputs a document that is printed, and controls a computer to function as:
a reception unit that receives information concerning the printing request of the user, including user identification information that identifies the user, and printing data that is a target of said printing request, via said communication network;
a first output unit that outputs a first output paper that has the user identification information received by said reception unit printed;
a second output unit that outputs a second output paper that has the printing data received by said reception unit printed, stacking the second output paper on the first output paper;
a determination unit that determines whether said printing data is printed on the surface of the back side of the last second output paper;
a third output unit that outputs a third output paper so that it is stacked on the second output paper, in a case where the determination unit determines that printing data is printed on the surface of the back side of the last second output paper, and
a packing unit that packs the first output paper, the second output paper, and the third output paper, in a stacked state.
